(19) United States
(12) Patent Application Publication
(10) Pub. No.: US 2025/0103081 A1
(43) Pub. Date: Mar. 27, 2025

(54) CORRECTION CIRCUIT FOR BANDGAP CIRCUIT

(71) Applicant: STMicroelectronics International N.V., Geneva (CH)

(72) Inventors: Jean-Pierre BLANC, Theys (FR); Sarah VERHAEREN, Le Versoud (FR)

(73) Assignee: STMicroelectronics International N.V., Geneva (CH)

(21) Appl. No.: 18/888,049

(22) Filed: Sep. 17, 2024

(30) Foreign Application Priority Data
Sep. 26, 2023 (FR) 2310175

(51) Int. Cl. G05F 3/26

(52) U.S. Cl. CPC G05F 3/262

(57) ABSTRACT

The present description concerns a correction circuit for a bandgap circuit comprising a first bipolar transistor and a second bipolar transistor, the bandgap circuit being configured to deliver a temperature-stable DC voltage based on the first and second bipolar transistors, the correction circuit being configured to generate a correction current equal to a difference in the base currents of said first and second transistors, and inject the correction current on the emitter of one of said first and second bipolar transistors to correct an error on the temperature-stable voltage resulting from a current gain difference between said first and second bipolar transistors.

This application claims the priority benefit of French Patent Application N°23/10175 filed on Sep. 26, 2023, entitled “Circuit de correction pour circuit à bande interdite,” which is hereby incorporated by reference to the maximum extent allowable by law.

### BACKGROUND

### Technical Field

The present disclosure generally concerns electronic circuits, for example integrated, and, more particularly, bandgap electronic circuits and electronic devices comprising such bandgap electronic circuits for generating a temperature-stable DC (“Direct Current”) voltage.

### Description of the Related Art

Known bandgap circuits comprise at least two bipolar transistors which receive equal currents on their respective collectors. The two bipolar transistors are of the same type, for example NPN, and have their bases interconnected. Further, one of the two bipolar transistors is P times larger than the other, P being a positive number greater than 1, that is, for example, the dimensions of the collector, emitter, and base regions of this bipolar transistor are P times larger than those of the collector, emitter, and base regions of the other bipolar transistor. For example, the transistor which is P times larger than the other corresponds to the placing in parallel of P transistors, each identical to the transistor which is P times smaller than the other.

The difference between the base-emitter voltages of these two transistors, that is, the voltage equal to the base-emitter voltage of the smallest one of the two transistors minus the base-emitter voltage of the largest one of these two transistors, then is of PTAT (“Proportional To Absolute Temperature”) type.

Since the base-emitter voltage of a bipolar transistor is further of CTAT (“Complementary To Absolute Temperature”) type, by properly sizing the bandgap circuit, a temperature-stable voltage may be obtained based on the base-emitter voltage difference of the two bipolar transistors, and on the base-emitter voltage of one of these two bipolar transistors or of another bipolar transistor of the bandgap circuit.

However, known bandgap circuits have various disadvantages that is would be advantageous to overcome.

### BRIEF SUMMARY

There exists a use for overcoming all or part of the disadvantages of known electronic bandgap circuits, and of known devices comprising known bandgap circuits for generating a temperature-stable voltage, or reference voltage.

For example, in bandgap circuits of the above-described type, for example implemented in FinFet technology, the value of the temperature-stable voltage delivered by the bandgap circuit may be different from a theoretical value for which the bandgap circuit has been sized.

An embodiment overcomes all or part of the disadvantages of known electronic bandgap circuits, and of known devices comprising known bandgap circuits for generating a temperature-stable voltage.

For example, an embodiment overcomes all or part of the disadvantages of known electronic bandgap circuits using the base-emitter voltage difference of bipolar transistors, for example of NPN type, for example implemented in FinFet technology.

An embodiment provides a correction circuit for a bandgap circuit comprising a first bipolar transistor and a second bipolar transistor, the bandgap circuit being configured to deliver a temperature-stable DC voltage based on a difference between a base-emitter voltage of the first bipolar transistor and a base-emitter voltage of the second bipolar transistor, the correction circuit being configured to:
generate a correction current equal to a difference between a base current of one of said first and second transistors and a base current of the other one of said two transistors; and
inject the correction current on the emitter of one of said first and second bipolar transistors to correct an error on a value of the temperature-stable voltage resulting from a current gain difference between said first and second bipolar transistors.

Another embodiment provides a device for generating a temperature-stable DC voltage, the device comprising:
a bandgap circuit comprising a first bipolar transistor and a second bipolar transistor and being configured to deliver a temperature-stable DC voltage based on a difference between a base-emitter voltage of the first bipolar transistor and a base-emitter voltage of the second bipolar transistor; and
the correction circuit such as described hereabove.

According to an embodiment:
the first bipolar transistor has smaller dimensions than the second bipolar transistor;
the first and second bipolar transistors have their bases connected together and their emitters coupled to a first node of application of a reference potential; and
the bandgap circuit comprises:
   a first MOS transistor having a source connected to a second node configured to receive a power supply potential and a drain coupled, preferably connected, to the collector of the first bipolar transistor, and
   a second MOS transistor identical to the first MOS transistor and having a source connected to the second node, a drain coupled, preferably connected, to the collector of the second bipolar transistor, and a gate connected to the gate of the first MOS transistor, the first and second MOS transistors being configured to deliver a first current to the first bipolar transistor and a second current equal to the first current to the second bipolar transistor.

According to an embodiment, the bandgap circuit comprises:
a first resistor connected between the emitter of the first bipolar transistor and the emitter of the second bipolar transistor; and
a second resistor connected between the emitter of the first bipolar transistor and the first node.

According to an embodiment, the bandgap circuit comprises:
a first resistor connected between the emitter of the first bipolar transistor and the first node;
a second resistor connected between the emitter of the second bipolar transistor and the first node;
an additional bipolar transistor having its collector connected to the second node;
an additional MOS transistor having its drain connected to the base of the additional bipolar transistor and coupled to the second node by a current source, its gate connected to the collector of the second bipolar transistor, and its source connected to the first node;
a capacitive element coupling the drain and the gate of the Additional MOS transistor; and
a third resistor connected between the emitter of the second bipolar transistor and the emitter of the additional bipolar transistor.

According to an embodiment, the correction circuit is configured to inject the correction current on the node of connection of the first resistor to the first bipolar transistor.

According to an embodiment, the correction circuit comprises:
a third MOS transistor and a third bipolar transistor in series between the first and second nodes;
a fourth MOS transistor and a fourth bipolar transistor in series between the first and second nodes;
a sixth MOS transistor having its gate connected to the node of connection of the third MOS transistor to the third bipolar transistor, its source connected to the base of the third bipolar transistor, and its drain connected to a third node;
a seventh MOS transistor having its gate connected to the node of connection of the fourth MOS transistor to the fourth bipolar transistor, its source connected to the base of the fourth bipolar transistor, and its drain connected to a fourth node;
a current mirror with MOS transistors coupling the third and fourth nodes; and
a voltage source coupling the third or fourth node to an output of the correction circuit configured to deliver the correction current.

According to an embodiment:
the third MOS transistor is identical to the first MOS transistor;
the third bipolar transistor is identical to the first bipolar transistor;
the fourth MOS transistor is identical to the second MOS transistor;
the fourth bipolar transistor is identical to the second bipolar transistor; and
a current ratio of the current mirror is equal to 1.

According to an embodiment:
the third MOS transistor is identical to the first MOS transistor;
the third bipolar transistor is identical to the first bipolar transistor;
the fourth MOS transistor is N times smaller than the second MOS transistor, with N a number greater than 1, for example equal to 2;
the fourth bipolar transistor is N times smaller than the second bipolar transistor; and
the current mirror comprises two MOS transistors having a dimension ratio N therebetween.

According to an embodiment:
the voltage source couples the third node to the output; and
the current mirror is configured to supply the third node with a current determined by the base current of the fourth bipolar transistor.

According to an embodiment, the output of the correction circuit is connected to the emitter of the first bipolar transistor.

According to an embodiment, the first and second bipolar transistors are of NPN type.

According to an embodiment, the transistors are implemented in FinFet technology.

### BRIEF DESCRIPTION OF THE SEVERAL VIEWS OF THE DRAWINGS

The foregoing features and advantages, as well as others, will be described in detail in the rest of the disclosure of specific embodiments given by way of illustration and not limitation with reference to the accompanying drawings, in which:

FIG. 1 illustrates an example of a bandgap circuit;

FIG. 2 illustrates another example of a bandgap circuit;

FIG. 3 shows an embodiment of an electronic device comprising the bandgap circuit of FIG. 1 and an embodiment of a correction circuit;

FIG. 4 shows an embodiment of an implementation of the correction circuit of FIG. 3; and

FIG. 5 shows an embodiment of an electronic device comprising the bandgap circuit of FIG. 2 and an embodiment of a correction circuit.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for the understanding of the described embodiments have been illustrated and described in detail. In particular, usual applications and electronic systems, for example a power on reset (POR) electronic system, where a bandgap circuit or a reference voltage generation device comprising a bandgap circuit may be provided, have not been detailed, these usual applications and electronic systems being compatible with the described embodiments and variants.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “front,” “back,” “top,” “bottom,” “left,” “right,” etc., or relative positions, such as terms “above,” “under,” “upper,” “lower,” etc., or to terms qualifying directions, such as terms “horizontal,” “vertical,” etc., it is referred, unless specified otherwise, to the orientation of the drawings.

Unless specified otherwise, the expressions “about,” “approximately,” “substantially,” and “in the order of” signify plus or minus 10%, preferably of plus or minus 5%.

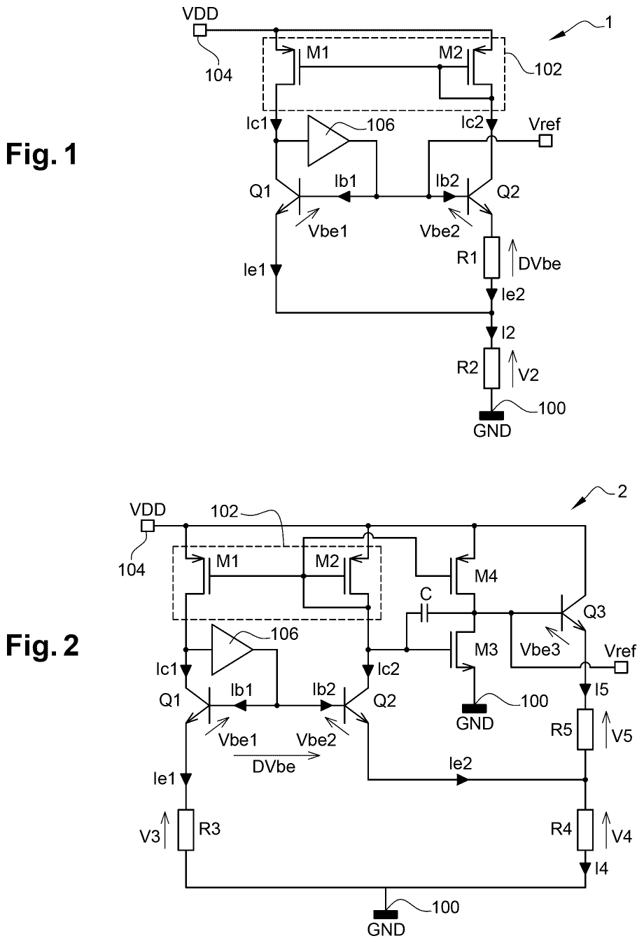

FIG. 1 illustrates an example of a bandgap circuit 1.

Circuit 1 comprises two bipolar transistors Q1 and Q2. Circuit 1 is configured to deliver a temperature-stable DC voltage Vref, that is, a voltage Vref having a constant value independent from temperature. More particularly, circuit 1 is configured to generate voltage Vref based on a voltage difference DVbe between the base-emitter voltages Vbe1 and Vbe2 of transistors Q1 and Q2. More particularly, voltage DVbe is equal to the base-emitter voltage Vbe1 of transistor Q1 minus the base-emitter voltage Vbe2 of transistor Q2 (DVbe=Vbe1−Vbe2).

Transistors Q1 and Q2 are for example of NPN type. Transistor Q2 is P times larger than transistor Q1, for example 8 times larger, it being understood that the value of number P may take other values greater than 1 than 8, these values not necessarily being integer values.

Transistors Q1 and Q2 have their bases connected together and their emitters each coupled to a node 100 of application of a reference potential GND, for example the ground.

Further, circuit 1 is configured so that transistor Q1 receives a collector current Ic1 and transistor Q2 receives a collector current Ic2 equal to current Ic1. Thus, circuit 1 comprises a current mirror 102 configured to deliver currents Ic1 and Ic2. Current mirror 102 is connected to the collector of transistor Q1, to the collector of transistor Q2, and to a node 104 configured to receive a power supply potential VDD, for example positive with respect to reference potential GND.

Current mirror 102 is implemented with MOS (“Metal Oxide Semiconductor”) transistors. More particularly, mirror 102 comprises a MOS transistor M1 having its source connected to node 104, and its drain coupled, preferably connected, to the collector of transistor Q1, as well as a MOS transistor M2 having its source connected to node 104, and its drain coupled, preferably connected, to the collector of transistor Q2. The gates of transistors M1 and M2 are connected to each other. As an example, the gate of transistor M2 is connected to the drain of transistor M2. As an alternative example, the gate of transistor M1 is connected to the drain of transistor M1. MOS transistors M1 and M2 are identical to each other, or, in other words, have the same dimensions. Thus, the dimension ratio of transistors M1 and M2 is equal to 1, or, in other words, the current ratio of current mirror 102 is equal to 1. Transistor M1 delivers current Ic1 to transistor Q1, transistor M2 delivering current Ic2 to transistor Q2.

Circuit 1 comprises a resistor R1 connected between the emitter of transistor Q2 and the emitter of transistor Q1, and a resistor R2 connected between the emitter of transistor Q1 and node 100. In other words, resistor R1 has a terminal coupled, preferably connected, to the collector of transistor Q2, and another terminal coupled, preferably connected, to the collector of transistor Q1, resistor R2 having a terminal coupled, preferably connected, to the collector of transistor Q2, and another terminal coupled, preferably connected, to node 100.

As an example, a buffer circuit 106 is provided between the collector and the base of transistor Q1. Although this is not shown in FIG. 1, this buffer circuit comprises, for example, a MOS transistor having its gate connected to the input of buffer circuit 106, which is itself connected to the collector of transistor Q1, a source connected to the output of circuit 106, which is itself connected to the bases of transistors Q1 and Q2, this MOS transistor being configured as a follower source, or, in other words, as a voltage follower.

As an alternative example, the buffer circuit may be replaced with a direct connection between the collector and the base of transistor Q1. As another alternative example, rather than coupling the collector and the base of transistor Q1 by means of the buffer circuit or a direct connection, the collector and the base of transistor Q2 are coupled to each other, by means of a buffer circuit or by a direct connection, the base and the collector of the transistor Q1 then not being coupled to each other by means of a direct connection or a buffer circuit.

Call Ib1 the base current of transistor Q1, and Ib2 the base current of transistor Q2. Further, call Ie1 the emitter current of transistor Q1 and Ie2 the emitter current of transistor Q2.

In the circuit 1 of FIG. 1, a temperature-stable voltage Vref is available on the base of transistor Q2. Voltage Vref is equal to the sum of voltage Vbe1 and of a voltage V2 across resistor R2. A current I2 equal to the sum of currents Ie1 and Ie2 flows through resistor R2. Thus:

$$Vref = Vbe 1 + V 2$$

$$Vref = Vbe 1 + I 2 * R 2.$$

If currents Ie1 and Ie2 are equal, then the current I2 in resistor R2 is equal to twice current Ie2, whereby:

$$Vref = Vbe 1 + 2 * Ie 2 * R 2 ,$$

$$Vref = Vbe 1 + 2 * ( DVbe / R 1 ) * R 2.$$

Since DVbe is equal to (K*T*In (P))/q, with K Boltzmann's constant, q the electron charge in Coulomb, and T the temperature in Kelvin, one obtains:

$$Vref = Vbe 1 + 2 * ( R 2 / R 1 ) * ( K * T / q ) * ln ( P ) .$$

Voltage Vref is then effectively dependent on voltage Vbe1, which is of CTAT type, and on a PTAT term proportional to temperature T, whereby, by properly sizing circuit 1, for example by the selection of the value of R1 and/or of the value of R2 and/or of number P, it is possible to obtain a voltage Vref independent from temperature.

FIG. 2 illustrates another example of a bandgap circuit 2.

Circuit 2 comprises, like circuit 1, elements Q1, M1, Q2, M2 and, in the example of FIG. 2, 106, the latter being connected together and to node 104 in the same way as in circuit 1. Thus, unless indicated otherwise, what has been described for these elements in relation with FIG. 1 applies in the circuit 2 of FIG. 2.

However, circuit 2 does not comprise resistors R1 and R2.

Circuit 2 comprises a resistor R3 connected between the emitter of transistor Q1 and node 100. For example, resistor R3 has a terminal coupled, preferably connected, to the emitter of transistor Q1, and another terminal coupled, preferably connected, to node 100.

Circuit 2 comprises a resistor R4 connected between the emitter of transistor Q2 and node 100. For example, resistor R4 has a terminal coupled, preferably connected, to the emitter of transistor Q2, and another terminal coupled, preferably connected, to node 100.

Circuit 2 comprises a bipolar transistor Q3. Transistor Q3 has its collector connected to node 104. Transistor Q3 is of the same type, for example NPN, as transistors Q1 and Q2.

Circuit 2 comprises a resistor R5 connected between the emitter of transistor Q2 and the emitter of transistor Q3. For example, resistor R5 has a terminal coupled, preferably connected, to the emitter of transistor Q2, and another terminal coupled, preferably connected, to the emitter of transistor Q3.

Circuit 2 comprises a MOS transistor M3 having its drain connected to the base of transistor Q3, its source connected to node 100, and its gate connected to the collector of transistor Q2. Transistor M3 has, for example, an N channel in this example where transistors Q1, Q2, and Q3 are NPN bipolar transistors.

A capacitive element C is connected between the gate and the drain of transistor M3. For example, capacitive element C has a terminal connected to the drain of transistor M3 and another terminal connected to the gate of transistor M3.

Transistor M3 is biased by a current source connected between the drain of transistor M3 and node 104. The current source couples the drain of transistor M3 to node 104. For example, the bias current source of transistor M3 is implemented by a MOS transistor M4 having its source connected to node 104, its drain connected to the drain of transistor M3, and its gate connected to the gates of the transistors M1 and M2 of current mirror 102.

In the same way as for circuit 1, the buffer circuit 106 of circuit 2 may be replaced with a direct connection.

A temperature-stable voltage Vref is available on the base of transistor Q3.

Voltage Vref is equal to the sum of a voltage V4 across resistor R4, of a voltage V5 across resistor R5, and of the base-emitter voltage Vbe3 of transistor Q3. Thus, Vref=V4+V5+Vbe3.

In circuit 2, voltage V5 is equal to the product of resistor R5 by the current I5 which flows through resistor R5. This current I5 is equal to the current I4 which flows through resistor R4 minus current Ie2, the current I4 through resistor R4 being equal to the ratio of voltage V4 by resistance R4. Thus, V5=R5*((V4/R4)−Ie2), whereby:

$$Vref = V 4 + R 5 * ( ( V 4 / R 4 ) - Ie 2 ) + Vbe 3$$

$$Vref = V 4 * ( 1 + ( R 5 / R 4 ) ) - R 5 * Ie 2 + Vbe 3.$$

In circuit 2, voltage V4 is equal to the sum of voltage DVbe and of a voltage V3 across resistor 3, this voltage V3 being equal to the product of current Ie1 by resistor R3. Thus, V4=DVbe+R3*Ie1. As a result:

$$Vref = DVbe * ( 1 + ( R 5 / R 4 ) ) + Ie 1 * R 3 * ( 1 + ( R 5 / R 4 ) ) - R 5 * Ie 2 + Vbe 3.$$

If currents Ie1 and Ie2 are equal (Ie1=Ie2), and if the value of resistor R3 is equal to the equivalent value of the two resistors R4 and R5 connected in parallel, then, the terms Ie1*R3*(1+(R5/R4)) and R5*Ie2 are equal and one obtains:

$$Vref = Dvbe * ( 1 + ( R 5 / R 4 ) ) + Vbe 3 ,$$

$$Vref = ( 1 + ( R 5 / R 4 ) ) * ( ( ( K * T ) / q ) * ln ( P ) ) + Vbe 3.$$

Voltage Vref is then effectively dependent on voltage Vbe3, which is of CTAT type, and on a PTAT term proportional to temperature T, whereby by properly sizing circuit 2, for example by the selection of the value of R4 and/or of the value of R5 and/or of number P, it is possible to obtain a voltage Vref independent from temperature.

There exist many other examples of bandgap circuits, where a temperature-stable reference voltage is generated based on a difference Dvbe between the base-emitter voltages of the bipolar transistors Q1 and Q2 such as described in relation with FIGS. 1 and 2.

However, in these circuits, the value of temperature-stable voltage Vref may not be that expected, that is, the value of the voltage Vref effectively obtained is different from the theoretical value of voltage Vref for which the circuit has been sized.

This particularly results from the fact that, even when the two transistors Q1 and Q2 receive equal currents Ic1 and Ic2, if the current gain β1 of transistor Q1 is not equal to the current gain β2 of transistor Q2, then currents Ie1 and Ie2 are not equal.

Indeed, Ie1=Ic1+Ib1 and Ie2=Ic2+Ib2, whereby Ie1=Ic1+Ic1/B1 and Ie2=Ic2+Ic2/B2. If gain B1 is different from gain B2 and currents Ic1 and Ic2 are equal, then currents Ie1 and Ie2 are different.

More particularly, when currents Ic1 and Ic2 are equal but gains B1 and B2 are different, then currents Ib1 and Ib2 are different and Ie1=Ie2+Ib1-Ib2, or, in other words Ie2=Ie1+Ib2-Ib1. The difference between currents Ib1 and Ib2 introduces an error between currents Ie1 and Ie2, which are no longer equal, and thus an error on the value of the obtained voltage Vref.

As an example, transistors Q1 and Q2 have different gains β1 and B2 when the bandgap circuits, for example circuits 1 and 2, are implemented in FinFet technology. Indeed, in this technology, the inventors have observed that the current gain β of a bipolar transistor depends on the density of collector current of this transistor. Now, in bandgap circuits comprising two transistors Q1 and Q2 such as previously described, the density of collector current of the two transistors Q1 and Q2 is not the same.

It is here provided to correct the error on the equality of currents Ie1 and Ie2, by generating a correction current Icorr equal to the difference between currents Ib1 and Ib2, and by injecting this correction current on the emitter of one of transistors Q1 and Q2 to make currents Ie1 and Ie2 equal, or, in other words, to correct an error on the value of voltage Vref which results from a current gain difference between transistors Q1 and Q2.

According to an embodiment, there is provided a correction circuit CORR configured to generate correction current Icorr, and to inject it on the emitter of one of the two transistors Q1 and Q2.

According to an embodiment, there is provided a device comprising a bandgap circuit comprising two transistors Q1 and Q2 such as described, the bandgap circuit being configured to generate a temperature-stable voltage, the device further comprising a circuit such as defined hereabove.

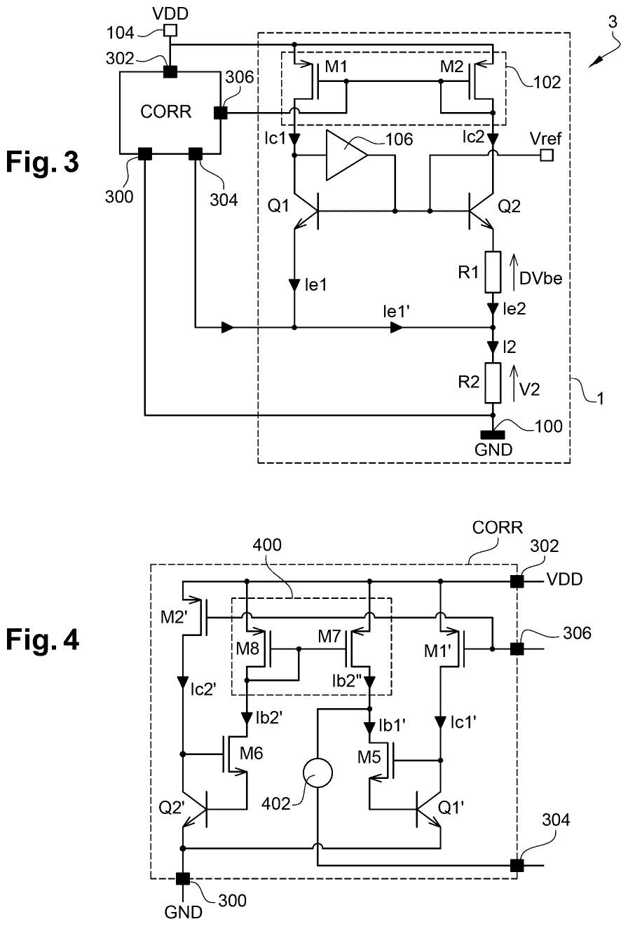

FIG. 3 shows an embodiment of an electronic device 3 comprising the bandgap circuit 1 of FIG. 1 and a correction circuit CORR according to an embodiment.

Device 3 is configured to deliver temperature-stable voltage Vref, this voltage Vref being delivered by the circuit 1 of device 3.

Circuit CORR is configured to deliver current Icorr. For example, circuit CORR comprises an output 304 configured to deliver current Icorr. In this embodiment, circuit CORR is configured to deliver current Icorr equal to current Ib2 minus current Ib1, or, in other words, Icorr=Ib2−Ib1.

Further, circuit CORR is configured to inject current Icorr on the emitter of one of the transistors Q1 and Q2 of circuit 1. In this embodiment, since Icorr=Ib2-Ib1, current Icorr is injected on the emitter of transistor Q1, or, in other words, on the node of connection of the emitter of transistor Q1 to resistor R2. Still in other words, the output 304 of circuit CORR is connected to the emitter of transistor Q1. Indeed, as previously indicated, when gains β1 and B2 are not equal, then Ie1=Ie2+Ib1−Ib2. By injecting current Icorr on the emitter of transistor Q1, that is, by adding current Icorr to current Ie1, a corrected emitter current Ie1′ equal to Ie1+Icorr is delivered to the node of interconnection of resistors R1 and R2 to each other. As a result:

$$Ie {1}^{′} = Ie 1 + Icorr ,$$

$$Ie {1}^{′} = Ie 2 + Ib 1 - Ib 2 + Ib 2 - Ib 1 ,$$

$$Ie {1}^{′} = Ie 2.$$

Referring to the calculations described in relation with FIG. 1:

$$Vref = Vbe 1 + 12 * R 2 ,$$

$$Vref = Vbe 1 + ( Ie {1}^{′} + Ie 2 ) * R 2 ,$$

$$Vref = Veb 1 + 2 * Ie * R 2 , although currents Ie 1 and Ie 2 are not equal .$$

As an example, circuit CORR is powered with voltage VDD. Circuit CORR then comprises a terminal 300 connected to node 100 and a terminal 302 connected to node 104.

As an example, circuit CORR has a terminal 306 connected to current mirror 102, for example to the gates of transistors M1 and M2 of mirror 102. Thereby, using MOS transistors assembled as a current mirror with transistors M1 and M2, circuit CORR may generate two currents determined by currents Ic1 and Ic2, and deliver these two currents respectively to two bipolar transistors so that a first one of these two bipolar transistors has a base current determined by current Ib1, and the other of these two bipolar transistors has a base current determined by current Ib2. These two currents, which are images of currents Ib1 and Ib2, are then delivered to a current summing node coupled to output 304 of circuit CORR so that current Icorr is equal to the difference of currents Ib1 and Ib2. For example, among the two currents images, one is delivered to the summing node by a current mirror, so that the resulting current Icorr is equal to the difference of currents Ib1 and Ib2.

There has been described in relation with FIG. 3 an embodiment where circuit CORR delivers a current Icorr equal to Ib2-Ib1, and this current is thus injected on the emitter of transistor Q1.

In another embodiment, current Icorr is equal to Ib1-Ib2. In this other embodiment, current Icorr is then injected on the emitter of transistor Q2. In this other embodiment, the current which flows through resistor R1 then is a current Ie2′ equal to the sum of currents Ie2 and Icorr. As a result:

$$Ie {2}^{′} = Ie 2 + Icorr ,$$

$$Ie {2}^{′} = Ie 1 + Ib 2 - Ib 1 + Ib 1 - Ib 2 ,$$

$$Ie {2}^{′} = Ie 1.$$

Referring to the calculations described in relation with FIG. 1:

$$Vref = Vbe 1 + 12 * R 2 ,$$

$$Vref = Vbe 1 + ( Ie 1 + Ie {2}^{′} ) * R 2 ,$$

$$Vref = Veb 1 + 2 * Ie * R 2 , although currents Ie 1 and Ie 2 are not equal .$$

Replacing Ie2′ with Dvbe/R1, one has:

$$Vref = Vbe 1 + 2 * ( R 2 / R 1 ) * DVbe ,$$

$$Vref = Vbe 1 + 2 * ( R 2 / R 1 ) * ( K * T / q ) * ln ( P ) although currents Ie 1 and Ie 2 are different .$$

FIG. 4 shows an embodiment of an implementation of the correction circuit of FIG. 3.

In this embodiment, circuit CORR comprises terminal 306 connected to current mirror 102 (not shown in FIG. 4), for example to the gates of transistors M1 and M2 of mirror 102. Circuit CORR further comprises a MOS transistor M1′ and a bipolar transistor Q1′ series-connected between terminals 302 and 300 of the circuit, that is between nodes 104 (VDD) and 102 (GND), these nodes 104 and 102 not being shown in FIG. 4. Circuit CORR further comprises a MOS transistor M2′ and a bipolar transistor Q2′ series-connected between terminals 302 and 300 of the circuit. Transistors M1′ and Q1′, respectively M2′ and Q2′, are configured so that the base current Ib1′ of transistor Q1′, respectively the base current Ib2′ of transistor Q2′, is an image current of the current Ib1 of transistor Q1, respectively of the current Ib2 of transistor Q2.

Transistors M1′ and M2′ are assembled as a current mirror with transistors M1 and M2, so that transistor M1′ delivers a current Ic1′ which is an image of current Ic1 and transistor M2′ delivers current Ic2′ which is an image of current Ic2. Transistors M1′ and M2′ have channels of same N or P type as those of transistors M1 and M2. For example, transistor M1′ has its source connected to terminal 302 and its gate connected to the gate of transistors M1 and M2, transistor M2′ having its source connected to terminal 302 and its gate connected to the gate of transistors M1 and M2.

Transistors Q1′ and Q2′ are of the same NPN or PNP type as transistors Q1 and Q2. Transistor Q1′ is connected to transistor M1′. More particularly, transistor Q1′ has its collector connected to the drain of transistor M1′ so as to receive current Ic1′. Symmetrically, transistor Q2′ is connected to transistor M2′. More particularly, transistor Q2′ has its collector connected to the drain of transistor M2′ so as to receive current Ic2′. Thus, current Ib1′, respectively Ib2′, is a current which is an image of current Ib1, respectively Ib2.

The emitters of transistors Q1′ and Q2′ are each coupled, preferably connected, to terminal 300.

According to an embodiment, transistors M1 and M1′ are identical, transistors M2 and M2′ are identical, transistors Q1 and Q1′ are identical, and transistors Q2 and Q2′ are identical, whereby currents Ib1′ and Ib2′ are equal to the respective currents Ib1 and Ib2.

Circuit CORR further comprises a transistor M5, for example having a channel of the type opposite to that of the channel of transistor M1′, and a transistor M6, for example having a channel of the type opposite to that of transistor M2′.

Transistor M5 has its gate connected to the collector of transistor Q1′, and its source connected to the base of transistor Q1′. Symmetrically, transistor M6 has its gate connected to the collector of transistor Q2′, and its source connected to the base of transistor Q2′.

Circuit CORR comprises a current mirror 400 with MOS transistors coupling the drains of transistors M5 and M6. The drain of one of transistors M5 and M6 has a current summing node function and is coupled to output 304. Current mirror 400 is configured so that the current Icorr supplied by output 304, that is, the current Icorr supplied by the summing node, is equal to the difference of currents Ib1 and Ib2.

More particularly, in this embodiment where current Icorr=Ib2−Ib1, the summing node coupled to output 304 is the drain of transistor M5. Current mirror 400 is then configured to deliver a current Ib2″ to the summing node (drain of transistor M5) so that current Icorr is equal to Ib2″−Ib1′, and Ib2″−Ib1′ is equal to Ib2−Ib1.

According to an embodiment, when transistors M1′, M2′, Q1′ and Q2′ are identical to the respective transistors M1, M2, Q1, and Q2, and currents Ib1′ and Ib2′ are then equal to the respective currents Ib1 and Ib2, current mirror 400 has a unit current ratio. In the example of FIG. 4, this signifies that current Ib2″ is equal to current Ib2′.

As an example, current mirror 400 comprises two MOS transistors M7 and M8, for example with a channel of the same type as that of the channels of transistors M1′ and M2′, having their gates connected to each other, and their sources connected to terminal 302. The drain of transistor M7 is connected to the drain of transistor M5, the drain of transistor M8 being connected to the drain of transistor M6. In this example, the drain of transistor M8 is connected to the gate of transistor M8.

To bias the summing node to a voltage adapted to the operation of MOS transistor current mirror 400, circuit CORR comprises a voltage source 402 connected between the summing node and output 304. For example, voltage source 402 has a terminal connected to the summing node and another terminal connected to output terminal 304.

As an example, this voltage source 402 is implemented by a MOS transistor having a channel of the same type as that of the channels of transistors M7 and M8 having its source connected to the summing node, its drain connected to output 304, and its gate connected to the source of transistor M5 or M6 which is not connected to the summing node.

There has been described hereabove an embodiment where circuit CORR delivers current Icorr=Ib2-Ib1. In another embodiment, where circuit CORR delivers current Icorr=Ib1-Ib2, the summing node then is the drain of transistor M6 and voltage source 402 couples the drain of transistor M6 to output 304. Further, current mirror 400 is then configured to deliver a current Ib1″ which is an image of current Ib1′ at the summing node, so that current Icorr is equal to Ib1″−Ib2′ and Ib1″−Ib2′=Ib1−Ib2. In this other embodiment, when transistors M1′, M2′, Q1′, and Q2′ are identical to the respective transistors M1, M2, Q1, and Q2, and their currents Ib1′ and Ib2′ are then equal to the respective currents Ib1 and Ib2, current mirror 400 has a unit current ratio, so that Ib1″ is equal to Ib1′.

Embodiments where transistors M1′, M2′, Q1′, and Q2′ are identical to the respective transistors M1, M2, Q1, and Q2, so that currents Ib1′ and Ib2′ are equal to the respective currents Ib1 and Ib2, have been described.

In other embodiments, to decrease the dimensions of transistor Q2′ as compared with those of transistor Q2, transistor Q2′ is not identical to transistor Q2, and is N times smaller than transistor Q2, with N a number or factor greater than 1, for example equal to 2. In these other embodiments, transistors M2′ then is N times smaller than transistor M1′, and transistors M7 and M8 have a dimension ratio equal to N, that is, transistor M7 is N times larger than transistor M8. Transistors M1′ and Q1′ remain identical to the respective transistors M1 and Q1.

As an example, one then has Ic1′=Ic1 and Ic2′=(1/N)*Ic2, whereby Ib1′=Ib1 and Ib2′=(1/N)*Ib2. Since M7 is N times larger than M8, or, in other words, current mirror 400 has a current ratio equal to N when the summing node is the drain of transistor M5, and to 1/N when the summing node is the drain of transistor M6. Thus, in the example of FIG. 4, Ib2″=N*Ib2′=N*(1/N)*Ib2, whereby Icorr=Ib2″−Ib1′=Ib2−Ib1.

Although there has been described in relation with FIG. 3 an embodiment of a device 3 where circuit CORR is connected to circuit 1, circuit CORR may be used with other bandgap circuits, for example with the circuit 2 of FIG. 2.

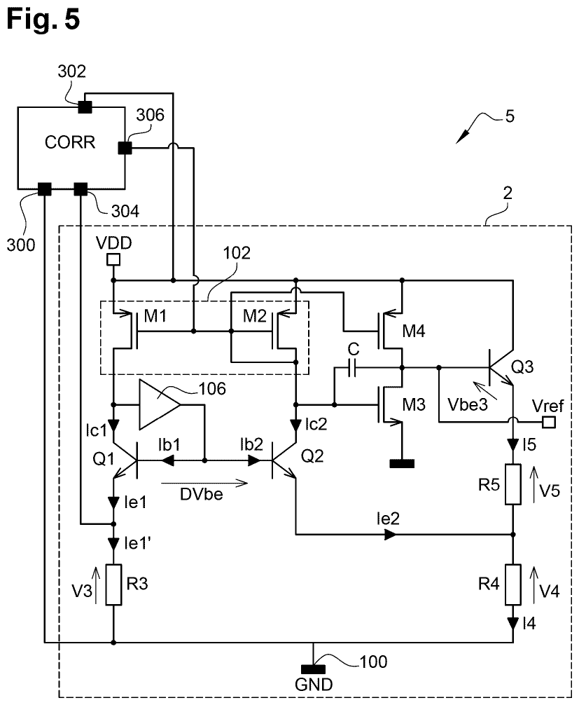

FIG. 5 shows an embodiment of an electronic device 5 comprising the bandgap circuit 2 of FIG. 2 and the circuit CORR of FIG. 3, for example implemented as described in relation with FIG. 4.

Device 5 is configured to deliver temperature-stable voltage Vref, this voltage Vref being delivered by the circuit 2 of device 5.

Circuit CORR is configured to deliver current Icorr. For example, circuit CORR comprises an output 304 configured to deliver current Icorr. In this embodiment, circuit CORR is configured to deliver current Icorr equal to current Ib2 minus current Ib1, or, in other words, Icorr=Ib2-Ib1.

Further, circuit CORR is configured to inject current Icorr on the emitter of one of the transistors Q1 and Q2 of circuit 1. In this embodiment, since Icorr=Ib2-Ib1, current Icorr is injected on the emitter of transistor Q1, or, in other words, on the node of connection of the emitter of transistor Q1 to resistor R3. Still in other words, the output 304 of circuit CORR is connected to the emitter of transistor Q1. By injecting current Icorr on the emitter of transistor Q1, that is, by adding current Icorr to current Ie1, a corrected emitter current Ie1′ equal to Ie1+Icorr flows through resistor R3. As a result:

$$Ie {1}^{′} = Ie 1 + Icorr ,$$

$$Ie {1}^{′} = Ie 2 + Ib 1 - Ib 2 + Ib 2 - Ib 1 ,$$

$$Ie {1}^{′} = Ie 2.$$

Referring to the calculations described in relation with FIG. 2:

$$Vref = DVbe * ( 1 + ( R 5 / R 4 ) ) + Ie {1}^{′} * R 3 * ( 1 + ( R 5 / R 4 ) ) - R 5 * Ie 2 + Vbe 3 , whereby :$$

$$Vref = Vref = DVbe * ( 1 + ( R 5 / R 4 ) ) + Ie 2 * ( R 3 * ( 1 + ( R 5 / R 4 ) ) - R 5 ) + V b e 3 .$$

By setting the value of resistor R3 equal to the equivalent value of resistors R4 and R5 connected in parallel, the terms R3*(1+(R5/R4)) and −R5 cancel each other and one effectively obtains:
Vref=(1+ (R5/R4))*(K*T/q)*ln (P)+Vbe3 although currents Ie1 and Ie2 are different.

In another embodiment, current Icorr is equal to Ib1-Ib2. In this other embodiment, current Icorr is then injected on the emitter of transistor Q2, that is on the node of connection of resistor R4 to resistor R5. In this other embodiment, the current I2 which flows through resistor R4 is then equal to the sum of a current Ie2′ and of current I5, with:

$$Ie {2}^{′} = Ie 2 + Icorr ,$$

$$Ie {2}^{′} = Ie 1 + Ib 2 - Ib 1 + Ib 1 - Ib 2 ,$$

$$Ie {2}^{′} = Ie 1.$$

Referring to the calculations described in relation with FIG. 2:

$$Vref = DVbe * ( 1 + ( R 5 / R 4 ) ) + Ie 1 * R 3 * ( 1 + ( R 5 / R 4 ) ) - R 5 * Ie {2}^{′} + Vbe 3 , whereby :$$

$$Vref = Vref = DVbe * ( 1 + ( R 5 / R 4 ) ) + Ie 1 * ( R 3 * ( 1 + ( R 5 / R 4 ) ) - R 5 ) + V b e 3 .$$

By setting the value of resistor R3 equal to the equivalent value of resistors R4 and R5 connected in parallel, the terms R3*(1+ (R5/R4)) and −R5 cancel each other and one effectively obtains:
Vref=(1+ (R5/R4))*(K*T/q)*ln (P)+Vbe3 although currents Ie1 and Ie2 are different.

Embodiments of devices 3 and 5 comprising circuit CORR and bandgap circuits, respectively 1 and 2, have been described. However, those skilled in the art are capable of providing other devices for generating a temperature-stable reference voltage Vref comprising:
a bandgap circuit configured to deliver voltage Vref based on a difference between the base-emitter voltage Vbe1 of a first bipolar transistor Q1 and the base-emitter voltage Vbe2 of a second bipolar transistor Q2, for example biased by a current mirror 102 as in circuits 1 and 2, and
correction circuit CORR configured to:
   generate correction current Icorr equal to the difference between a base current of one of transistors Q1 and Q2 and a base current of the other of transistors Q1 and Q2; and
   inject current Icorr on the emitter of one of bipolar transistors Q1 and Q2 to correct an error on a value of voltage Vref resulting from a difference between the current gains β1 and β2 of transistors Q1 and Q2, or, in other words, to correct an error in the equality of the emitter currents Ie1 and Ie2 of transistors Q1 and Q2, which results from the difference between the current gains β1 and β2 of transistors Q1 and Q2.

As previously indicated, the difference between current gains β1 and β2 for example results from a variation of the current gain β of a bipolar transistor with its density of collector current.

For example, bipolar transistors implemented in FinFet technology exhibit a variation of their current gain β with the density of collector current. Thus, according to an embodiment, the bipolar and MOS transistors of a device for generating a temperature-stable voltage Vref which comprises a bandgap circuit and circuit CORR are all implemented in FinFet technology.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove. In particular, those skilled in the art are capable of sizing the bandgap circuits configured to generate voltage Vref.

A correction circuit (CORR) for a bandgap circuit (1; 2) is summarized as including a first bipolar transistor (Q1) and a second bipolar transistor (Q1, Q2), the bandgap circuit being configured to deliver a temperature-stable DC voltage (Vref) based on a difference (Dvbe) between a base-emitter voltage (Vbe1) of the first bipolar transistor (Q1) and a base-emitter voltage (Vbe2) of the second bipolar transistor (Q2), the correction circuit being configured to: generate a correction current (Icorr) equal to a difference between a base current (Ib2) of one of said first and second transistors (Q2) and a base current of the other one of said two transistors (Q1); and inject the correction current (Icorr) on the emitter of one of said first and second bipolar transistors (Q1) to correct an error on a value of the temperature-stable voltage (Vref) resulting from a current gain difference between said first and second bipolar transistors (Q1, Q2).

A device (3, 5) for generating a temperature-stable DC voltage (Vref) is summarized as including: a bandgap circuit (1; 2) including a first bipolar transistor (Q1) and a second bipolar transistor (Q1) and being configured to deliver a temperature-stable DC voltage (Vref) based on a difference (Dvbe) between a base-emitter voltage (Vbe1) of the first bipolar transistor (Q1) and a base-emitter voltage (Vbe2) of the second bipolar transistor (Q2); and the correction circuit (CORR).

The first bipolar transistor (Q1) has smaller dimensions than the second bipolar transistor (Q2); the first and second bipolar transistors (Q1, Q2) have their bases connected together and their emitters coupled to a first node (100) of application of a reference potential (GND); and the bandgap circuit (1; 2) includes: a first MOS transistor (M1) having a source connected to a second node (104) configured to receive a power supply potential (VDD) and a drain coupled, preferably connected, to the collector of the first bipolar transistor (Q1), and a second MOS transistor (M2) identical to the first MOS transistor (M1) and having a source connected to the second node (104), a drain coupled, preferably connected, to the collector of the second bipolar transistor (Q2) and a gate connected to the gate of the first MOS transistor (M1), the first and second MOS transistors (M1, M2) being configured to deliver a first current (Ic1) to the first bipolar transistor (Q1) and a second current (Ic2) equal to the first current to the second bipolar transistor (Q2).

The device wherein the bandgap circuit (1) includes: a first resistor (R1) connected between the emitter of first bipolar transistor (Q1) and the emitter of the second bipolar transistor (Q2); and a second resistor (R2) connected between the emitter of the first bipolar transistor (Q1) and the first node (100).

The bandgap circuit (2) includes: a first resistor (R3) connected between the emitter of the first bipolar transistor (Q1) and the first node (100); a second resistor (R4) connected between the emitter of second bipolar transistor (Q2) and the first node (100); an additional bipolar transistor (Q3) having its collector connected to the second node (104); an additional MOS transistor (M3) having its drain connected to the base of the additional bipolar transistor (Q3) and coupled to the second node (104) by a current source (M4), its gate connected to the collector of the second bipolar transistor (Q2), and its source connected to the first node (100); a capacitive element (C) coupling the drain and the gate of the additional MOS transistor (M3); and a third resistor (R5) connected between the emitter of the second bipolar transistor (Q2) and the emitter of the additional bipolar transistor (Q3).

The correction circuit (CORR) is configured to inject the correction current (Icorr) on the node of connection of the first resistor (R1; R3) to the first bipolar transistor (Q1).

The correction circuit (CORR) includes: a third MOS transistor (M1′) and a third bipolar transistor (Q1′) in series between the first and second nodes (100, 104); a fourth MOS transistor (M2′) and a fourth bipolar transistor (Q2′) in series between the first and second nodes (100, 104); a sixth MOS transistor (M5) having its gate connected to the node of connection of the third MOS transistor (M1′) to the third bipolar transistor (Q1′), its source connected to the base of the third bipolar transistor (Q1′), and its drain connected to a third node; a seventh MOS transistor (M6) having its gate connected to the node of connection of the fourth MOS transistor (M2′) to the fourth bipolar transistor (Q2′), its source connected to the base of the fourth bipolar transistor (Q2′), and its drain connected to a fourth node; a current mirror (400) with MOS transistors (M7, M8) coupling the third and fourth nodes; and a voltage source (402) coupling the third or fourth node to an output (304) of the correction circuit (CORR) configured to deliver the correction current (Icorr).

The third MOS transistor (M1′) is identical to the first MOS transistor (M1); the third bipolar transistor (Q1′) is identical to the first bipolar transistor (Q1); the fourth MOS transistor (M2′) is identical to the second MOS transistor (M2); the fourth bipolar transistor (Q2′) is identical to the second bipolar transistor (Q2); and a current ratio of the current mirror (400) is equal to 1.

The third MOS transistor (M1′) is identical to the first MOS transistor (M1); the third bipolar transistor (Q1′) is identical to the first bipolar transistor (Q1); the fourth MOS transistor (M2′) is N times smaller than the second MOS transistor (M2), with N a number greater than 1, for example equal to 2; the fourth bipolar transistor (Q2′) is N times smaller than the second bipolar transistor (Q2); and the current mirror includes two MOS transistors (M7, M8) having a dimension ratio N therebetween.

The voltage source (402) couples the third node to the output; and the current mirror (400) is configured to supply the third node with a current (Ib2″) determined by the base current (Ib2) of the fourth bipolar transistor (Q2′).

The output (304) of the correction circuit (CORR) is connected to the emitter of the first bipolar transistor (Q1).

The first and second bipolar transistors (Q1, Q2) are of NPN type.

The transistors (Q1, Q2, M1, M2, Q1′, Q2′, M1′, M2′) are implemented in FinFet technology.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A circuit, comprising:
a bandgap circuit including:
a first bipolar transistor; and
a second bipolar transistor, the bandgap circuit being configured to deliver a temperature-stable DC voltage based on a difference between a base-emitter voltage of the first bipolar transistor and a base-emitter voltage of the second bipolar transistor; and
a correction circuit configured to:
generate a correction current equal to a difference between a base current of one of the first and second transistors and a base current of the other one of the first and second transistors; and
inject the correction current on an emitter of one of the first and second bipolar transistors to correct an error on a value of the temperature-stable voltage resulting from a current gain difference between the first and second bipolar transistors.

2. The circuit according to claim 1, wherein the correction circuit includes a third bipolar transistor and a fourth bipolar transistor.

3. The circuit according to claim 2, wherein the correction circuit further includes:
a first metal-oxide-semiconductor (MOS) transistor coupled in series to the third bipolar transistor; and
a second MOS transistor coupled in series to the fourth bipolar transistor.

4. The circuit according to claim 2, wherein the third bipolar transistor is smaller than the fourth bipolar transistor.

5. The circuit according to claim 3, further comprising:
a third MOS transistor; and
a fourth MOS transistor, a gate of the fourth MOS transistor being coupled directly to a gate of the third MOS transistor.

6. A device, comprising:
a bandgap circuit including:
a first bipolar transistor; and
a second bipolar transistor, the bandgap circuit being configured to deliver a temperature-stable DC voltage based on a difference between a base-emitter voltage of the first bipolar transistor and a base-emitter voltage of the second bipolar transistor; and
a correction circuit configured to generate a correction current equal to a difference between a base current of one of the first and second transistors and a base current of the other one of the first and second transistors.

7. The device according to claim 6, wherein:
the first bipolar transistor has smaller dimensions than the second bipolar transistor;
the first and second bipolar transistors have their bases connected together and their emitters coupled to a first node of application of a reference potential; and
the bandgap circuit includes:
a first metal-oxide-semiconductor (MOS) transistor having a source connected to a second node configured to receive a power supply potential and a drain coupled to the collector of the first bipolar transistor; and
a second MOS transistor identical to the first MOS transistor and having a source connected to the second node, a drain coupled to the collector of the second bipolar transistor, and a gate connected to a gate of the first MOS transistor, the first and second MOS transistors being configured to deliver a first current to the first bipolar transistor and a second current equal to the first current to the second bipolar transistor.

8. The device according to claim 7, wherein the bandgap circuit comprises:
a first resistor coupled between an emitter of first bipolar transistor and an emitter of the second bipolar transistor; and
a second resistor coupled between the emitter of the first bipolar transistor and the first node.

9. The device according to claim 7, wherein the bandgap circuit comprises:
a first resistor connected between an emitter of the first bipolar transistor and the first node;
a second resistor connected between an emitter of second bipolar transistor and the first node;
a third bipolar transistor having a collector coupled to the second node;
a third MOS transistor having a drain coupled to a base of the third bipolar transistor and coupled to the second node by a current source, its gate coupled to the collector of the second bipolar transistor, and its source connected to the first node;
a capacitive element coupling the drain and the gate of the additional MOS transistor; and
a third resistor coupled between the emitter of the second bipolar transistor and an emitter of the additional bipolar transistor.

10. The device according to claim 8, wherein the correction circuit is configured to inject the correction current on a node of connection of the first resistor to the first bipolar transistor.

11. A device, comprising:
a bandgap circuit including:
a first bipolar transistor;
a second bipolar transistor;
a first metal-oxide-semiconductor (MOS) transistor having a source connected to a second node configured to receive a power supply potential and a drain coupled to the collector of the first bipolar transistor; and
a second MOS transistor having a source connected to the second node, a drain coupled to the collector of the second bipolar transistor, and a gate connected to a gate of the first MOS transistor, the first and second MOS transistors being configured to deliver a first current to the first bipolar transistor and a second current equal to the first current to the second bipolar transistor; and
a correction circuit including:
a third MOS transistor;
a third bipolar transistor coupled in series with the third MOS transistor between the first and second nodes;
a fourth MOS transistor;
a fourth bipolar transistor coupled in series with the fourth MOS transistor between the first and second nodes; and
a voltage source coupling the third or fourth node to an output of the correction circuit configured to deliver the correction current.

12. The device according to claim 11, further comprising:
a fifth MOS transistor having its gate connected to the node of connection of the third MOS transistor to the third bipolar transistor, its source connected to the base of the third bipolar transistor, and its drain connected to a third node; and
a sixth MOS transistor having its gate connected to the node of connection of the fourth MOS transistor to the fourth bipolar transistor, its source connected to the base of the fourth bipolar transistor, and its drain connected to a fourth node.

13. The device according to claim 12, further comprising a current mirror including a seventh MOS transistor and an eighth MOS transistor coupling the third and fourth nodes.

14. The device according to claim 11, wherein:
the third MOS transistor is identical to the first MOS transistor;
the third bipolar transistor is identical to the first bipolar transistor;
the fourth MOS transistor is identical to the second MOS transistor;
the fourth bipolar transistor is identical to the second bipolar transistor; and
a current ratio of the current mirror is equal to 1.

15. The device according to claim 13, wherein:
the third MOS transistor is identical to the first MOS transistor;
the third bipolar transistor is identical to the first bipolar transistor;
the fourth MOS transistor is N times smaller than the second MOS transistor, with N being a number greater than 1;
the fourth bipolar transistor is N times smaller than the second bipolar transistor; and
the current mirror comprises two MOS transistors having a dimension ratio N therebetween.

16. The device according to claim 13, wherein:
the voltage source couples the third node to the output; and
the current mirror is configured to supply the third node with a current determined by the base current of the fourth bipolar transistor.

17. The device according to claim 16, wherein the output of the correction circuit is connected to the emitter of the first bipolar transistor.

18. The device according to claim 11, wherein the first and second bipolar transistors are of NPN type.

19. The device according to claim 6, wherein the first, second, third, and fourth bipolar transistors and first, second, third, and fourth MOS transistors are implemented in FinFet technology.

20. The device according to claim 11, wherein the correction circuit is configured to:
generate a correction current equal to a difference between a base current of one of the first and second transistors and a base current of the other one of the first and second transistors; and
inject the correction current on an emitter of one of the first and second bipolar transistors to correct an error on a value of the temperature-stable voltage resulting from a current gain difference between the first and second bipolar transistors.
